(19) United States
(12) Patent Application Publication
(10) Pub. No.: US 2022/0333775 A1
(43) Pub. Date: Oct. 20, 2022

(54) CANDLE TRAP SAFETY ASSEMBLY

(71) Applicant: John A. LaGattuta, Cleveland, OH (US)

(72) Inventor: John A. LaGattuta, Cleveland, OH (US)

(21) Appl. No.: 17/720,714

(22) Filed: Apr. 14, 2022

Related U.S. Application Data
(60) Provisional application No. 63/174,666, filed on Apr. 14, 2021.

(51) Int. Cl. F23Q 25/00; F21V 35/00

(52) U.S. Cl. CPC F23Q 25/00; F21V 35/00

(57) ABSTRACT

A candletrap assembly and method are disclosed. The assembly includes a housing that defines a cavity to hold a candle therein. A cap is attached to the housing by a closing spring hinge mechanism with a biasing member. An elongated pin may extend through the housing to abut against a surface and a portion of the cap to hold the cap in an open position against the bias force of the biasing member. Once the housing is tipped or moved relative to the surface, the closing spring hinge mechanism is configured to automatically bias the cap to a closed position against an open end of the housing. The cap may be held in the closed position against a lid of the housing to secure the candle therein. The candletrap assembly can snuff out a live flame of the candle and retain the candle safely therein when tipped.

### CROSS-REFERENCE TO RELATED APPLICATIONS

This application claims priority to and the benefit of U.S. Provisional Patent Application No. 63/174,666 filed Apr. 14, 2021 and titled, “CANDLETRAP SAFETY ASSEMBLY” which is incorporated herein in its entirety.

### FIELD OF INVENTION

The present disclosure generally relates to a safety device for a candle that is configured to snuff out a flame and to maintain the candle within a safe housing when the device is bumped, lifted, or tipped.

### BACKGROUND

Candles remain an attractive and long standing way to provide a comfortable, welcoming, feeling while at the same time masking undesired odors. Unfortunately, since candles require the use of an open flame, they represent a significant safety risk as well. Candles may inadvertently be left with an active flame while folks leave the premises, fall asleep, or otherwise not pay attention to the existence of an active flame. Further, candles may be placed on surfaces such as shelves, tables, or counters that can be bumped, lifted, or tipped over due to user error or the presence of pets, children, or other unintended force against the surface such as an earthquake. These are common occurrences that pose a safety risk which may result in a fire or damage to property.

Also, unlike many heating or electrical appliances, candles do not have an automatic shut off that can be relied on for safety. Accordingly, there exists a need for a safety device that allows a candle flame to be automatically and safely extinguished to address the concerns as described above.

### SUMMARY

Provided is a candle safety assembly and method is shown and described herein. The candletrap assembly includes a housing that defines a cavity to hold a candle therein. A cap is attached to the top of the housing by a closing spring hinge mechanism. The closing spring hinge mechanism includes a biasing member and an elongated pin that extends through the housing to abut against a surface and a portion of the cap to hold the cap in an open engaged position against the bias force of the biasing member. Once the housing is tipped relative to the surface, the closing spring hinge mechanism is configured to automatically bias the cap to a closed position against an open end of the housing. The cap may be held in the closed position against a lid of the housing to secure the candle therein by at least one magnet positioned along the housing or cap. The candletrap assembly can snuff out a live flame of the candle and retain the candle safely therein when tipped.

In one embodiment, provided is a candletrap assembly comprising a housing with a sidewall that defines a cavity, the sidewall having a bottom end and an open top end, the top end is defined by a rim, a base is positioned on the bottom end of the housing. A spring hinge mechanism attached to the housing adjacent the open top end and a cap wherein the spring hinge mechanism is configured to be biased to position the cap between an open position and a closed position relative to the open end of the housing; and an elongated pin extending through at least a length of the housing wherein the elongated pin is configured to hold the cap in the open position against a bias force of the spring hinge mechanism.

The housing may include a generally cylindrical shape and the base may be formed separately from the housing and attached to the bottom end. The cap may have a perimeter edge that has a shape that is generally complimentary to the open end of the housing such that the perimeter edge of the cap extends outwardly from the inner surface of the cavity wherein at least a portion of the cap abuts against the rim of the housing when in the closed position. The cap may have a perimeter edge that is generally circular. A plurality of magnets may be positioned along the rim of the housing and be configured to magnetically attract to the cap wherein the cap comprises a magnetically attractive material such that a magnetic attraction between the cap and the at least one magnet positioned along the rim may be strong enough to support the cap in the closed position as the assembly is positioned upside down to maintain a candle within the cavity.

The cap may include a peripheral edge having a generally curved or circular configuration with a cutout section placed along the perimeter edge that includes a ledge. The ledge may be placed adjacent to the closing spring hinge mechanism to interact with the elongated pin. The closing spring hinge mechanism may include a first plate, a second plate, a biasing member, and a rod, wherein the first plate is attached to the housing and the second plate is attached to the cap wherein the biasing member is configured to bias the first plate towards the second plate to close the cap relative to the open end of the housing. The rod may be positioned along a pivot axis and extend from a first connection member to a second connection member. The first connection member may extend from the second plate and the second connection member may extend from the first plate along the pivot axis. A first bearing member may extend generally perpendicularly from the first plate and supports the rod and second bearing member may extend generally perpendicularly from the second plate and support the rod wherein the first bearing member is spaced from the second bearing member along the pivot axis. The biasing member may be a spring that may be positioned along the rod. The first plate may include a first arm and a second arm that are spaced apart from one another and separately attached to the housing. The second plate may include a space that extends between the first and second connection members such that a ledge of the cap is positioned within the space of the second plate.

The elongated pin may extend through the housing to abut against a surface and a portion of the cap to hold the cap in an open position against the bias force of the biasing member. The closing spring hinge mechanism may be configured to automatically bias the cap to a closed position against an open end of the housing once the elongated pin is removed from a portion of the cap. The elongated pin may include a head and an opposite end wherein the elongated pin is positioned within a through hole that extends between the rim of the housing and a bottom of the housing such that the head of the elongated pin is placed adjacent the closing spring hinge mechanism wherein the elongated pin is longer than a length of the housing to allow the end of the elongated pin to abut against a surface and to allow the head to protrude upwardly from the rim. The elongated pin may include a bushing positioned adjacent to the end. The head of the elongated pin may be configured to be manually placed against a ledge of the cap to place the cap in the open position.

Once the bottom of the housing is tipped, nudged, lifted, or bumped relative to a surface, an end of the elongated pin may be moved from an abutment with the surface and moved away from alignment with the bottom of the housing wherein a bias force of the closing spring hinge mechanism biases against the head and the head disengages from the ledge and the closing spring hinge mechanism pivots the cap to the closed position against the open end of the housing.

In another embodiment, the candletrap assembly may further comprise a replaceable surface cover configured to wrap around the outer surface of the housing. The cover may include first and second notches that are generally complementary shaped relative to the spring hinge mechanism.

### BRIEF DESCRIPTION OF THE DRAWINGS

Operation of the disclosure may be better understood by reference to the following detailed description taken in connection with the following illustrations, wherein:

FIG. 1 is a perspective front view of an embodiment of a candletrap assembly of the present disclosure in a closed position;

FIG. 2 is a perspective front view of the candletrap assembly of the present disclosure in an open position;

FIG. 3 is an enlarged rear view of a closing spring hinge mechanism of the candletrap assembly of FIG. 2 in a closed position;

FIG. 4A is a cross sectional rear view of a closing spring hinge mechanism of the candletrap assembly in an open position;

FIG. 4B is an enlarged rear view of the closing spring hinge mechanism of the candletrap assembly of FIG. 2 in an open position;

FIG. 5 is a cross sectional side view of the candletrap assembly in the open position;

FIG. 6 is a perspective rear view of the candletrap assembly of the present disclosure in a tipped position relative to a surface;

FIG. 7 is a perspective front view of the candletrap assembly of the present disclosure in the open position;

FIG. 8 is a perspective view of the candletrap assembly of the present disclosure in a closed position and positioned upside down;

FIG. 9 is a perspective view of a base of the candletrap assembly of the present disclosure;

FIG. 10A is a perspective view of an embodiment of an elongated pin of the candletrap assembly of the present disclosure;

FIG. 10B is a perspective view of another embodiment of an elongated pin of the candletrap assembly of the present disclosure;

FIG. 11 is a perspective view of a housing of the candletrap assembly of the present disclosure;

FIG. 12 is a perspective view of a cap of the candletrap assembly of the present disclosure;

FIG. 13 is a plan view of a replaceable surface cover for the candletrap assembly of the present disclosure.

### DETAILED DESCRIPTION

Reference will now be made in detail to embodiments of the present disclosure, examples of which are illustrated in the accompanying drawings. It is to be understood that other embodiments may be utilized and structural and functional changes may be made without departing from the respective scope of the disclosure. Moreover, features of the various embodiments may be combined or altered without departing from the scope of the disclosure. As such, the following description is presented by way of illustration only and should not limit in any way the various alternatives and modifications that may be made to the illustrated embodiments and still be within the spirit and scope of the disclosure.

A candletrap assembly 10 is disclosed and may be of any appropriate configuration and is not limited to that shown and described herein. It should similarly be understood that the candletrap assembly 10 may be adapted to any appropriate size and may be made of any appropriate materials and colors or with markings or indicia thereon and this disclosure is not limited in this regard. The term “candletrap” used herein shall be broadly construed to define any device configured to snuff out or otherwise extinguish a flame, embodiments of which are more fully disclosed herein.

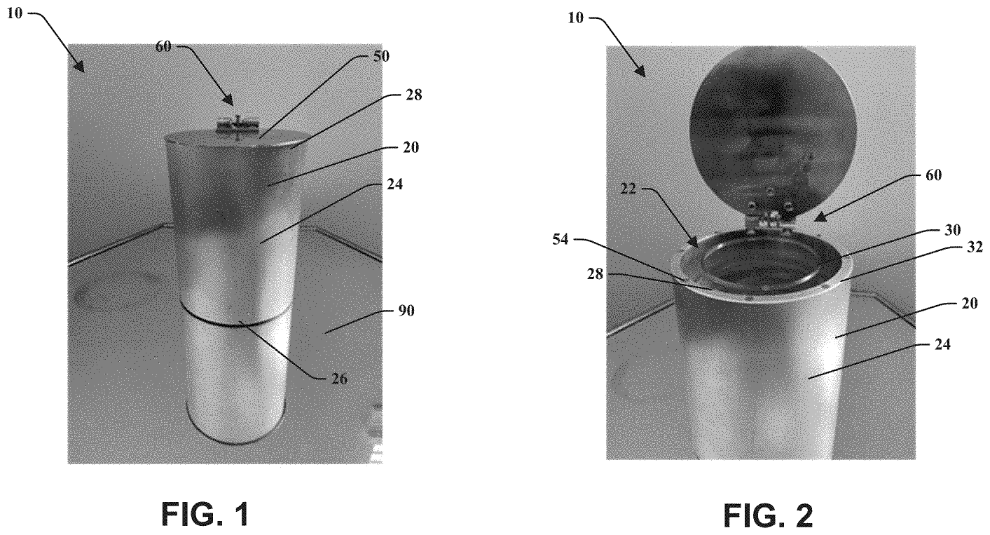

FIG. 1 is a perspective view of an embodiment of the candletrap assembly 10 that may include a housing 20 that defines a cavity 22 for supporting a candle 30 therein. The housing may have a sidewall 24 formed in a cylinder shape that includes generally smooth outer and inner surfaces. A base 40 may be shaped to be positioned or otherwise attached to a bottom end 26 of the housing 20 to define the cavity 22. A cap 50 may be rotatably or pivotally attached to the housing 20 by a closing spring hinge mechanism 60 as will be described more fully below.

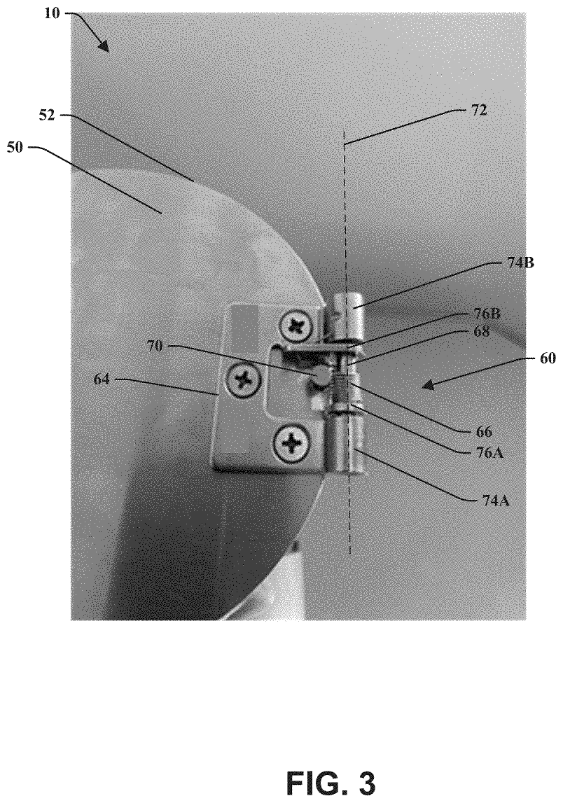

The candletrap assembly 10 may be configured to receive a candle 30 within the cavity 22 through an open end 28 opposite the bottom end 26. The closing spring hinge mechanism 60 may allow the cap 50 to held in and to remain in an open position (FIG. 2). A user may light the candle 30 and allow the candle along with an active flame to be exposed to the surrounding environment while the assembly 10 is maintained in the open position by the closing spring hinge mechanism 60. The cap 50 may be able to automatically bias from the open position to a closed position once the assembly 10 has been tipped, lifted, nudged, or bumped. In this instance, the cap 50 may automatically bias to the closed position to encase the candle 30 and extinguish the active flame within the now closed cavity 22. This action is designed to safely snuff out the active flame once the assembly is bumped, nudged, lifted, or tipped. Further, in an embodiment, the assembly 10 is configured to allow the cap 50 to be held firmly shut against the open end 28 of the housing 20 to support the candle 30 therein. The force of the cap 30 held against the housing 20 is such that the weight of the candle can be safely held within the cavity 22 if the assembly 10 has been knocked over, fell from an elevated surface, or become upside down.

The candle 30 may be a cylindrical shaped candle such as those sold are retail stores or online. In one embodiment, the candle 30 may include a glass enclosure. The candletrap assembly may include a shape and size configured to receive, support and function with various sizes and shapes of candles 30. The particular length and width/diameter of the candletrap assembly may be in a predetermined shape that is complementary to the shapes of various candles 30 such that as the candletrap is tipped or otherwise falls, the candle is configured to remain in tacked while extinguishing the flame therein. In other words, the glass portion of the candle 30 may remain unbroken due to the complimentary shape of the cavity relative to the shape of the candle 30 and associated glass enclosure such that minimal to no movement of the candle 30 would occur in both the radial (against the inner sidewall of the housing) and lateral (towards or away from the closed cap) directions once the candletrap assembly has been tipped, lifted, nudged, or bumped or otherwise falls from the surface.

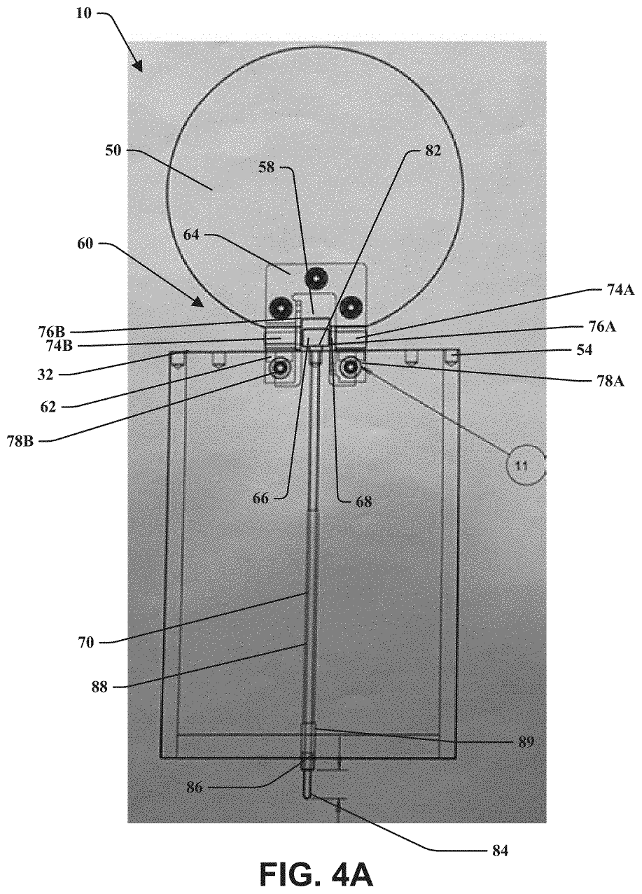

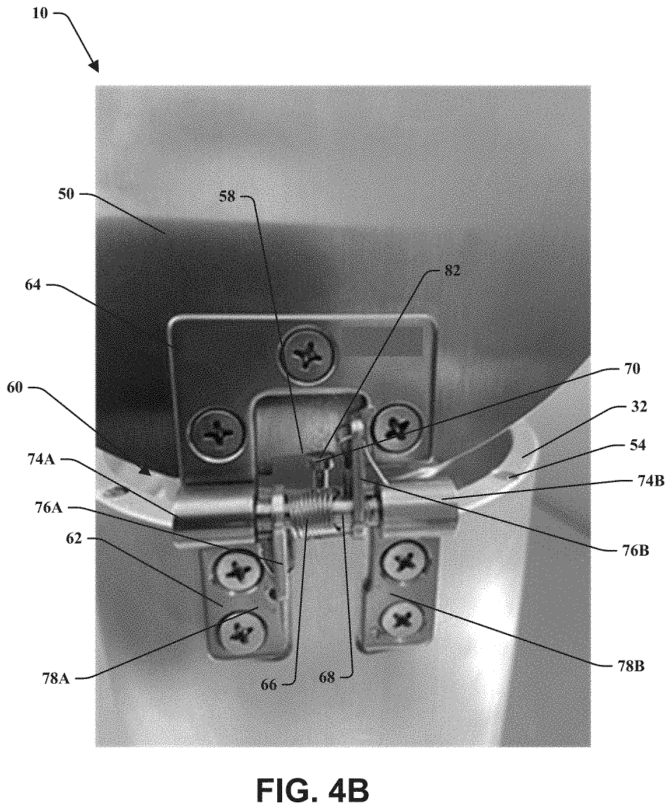

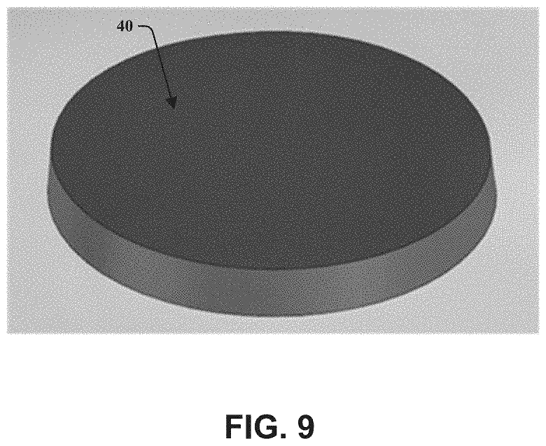

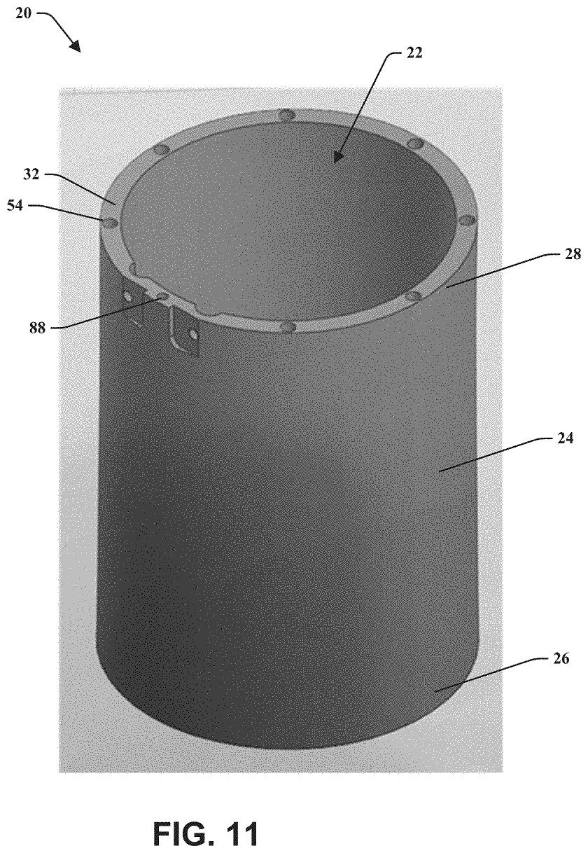

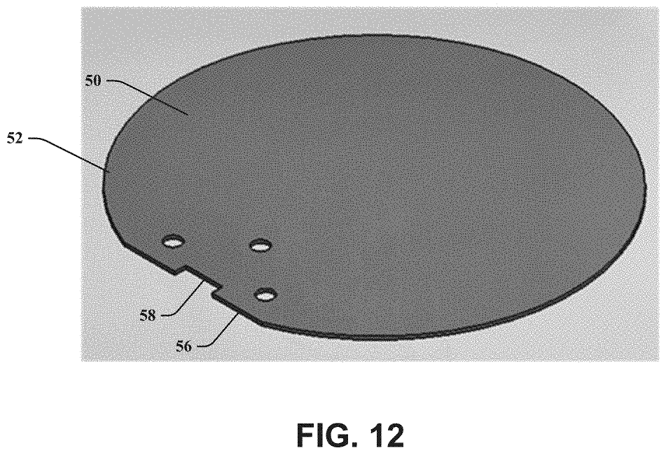

FIG. 1 shows that candletrap assembly 10 in the closed position while FIG. 2 illustrates the candletrap assembly 10 in the opened position. The housing 20 (FIG. 11), base 40 (FIG. 9), cap 50 (FIG. 12), and closing spring hinge mechanism 60 (FIGS. 3, 4A, and 4B) may be made of various materials and come in various sizes to allow the assembly to function as described. The housing 20 may be made of a rigid material such as a plastic, polymer, metal or alloy. The housing 20 may be made of a combination of materials, and is contemplated to possibly include coatings or layers of various embodiments to be formed to allow the candle 30 to be safely positioned within the cavity 22 while reducing the risk of the assembly 10 catching fire but also made of sufficiently durable materials to allow the assembly to be knocked down with reduced risk of cracking or breaking and to allow for its continued use. In one embodiment, the housing 20 may be made of aluminum and the cavity 22 is bored or otherwise formed through a cylindrical material. In another embodiment, the housing 20 is made of a polymer such as PVC and at least a portion of the housing may be molded or extruded to form the desired shape. The housing 20 may be generally cylindrical shape with a sidewall 24 that defines the bottom end 26 and the open top end 28. The top end 28 may be defined by a rim 32. The base 40 (see also FIG. 9) may be formed separately from the housing 20 but may be attached to the bottom end 28. In an embodiment, the base 40 may be made from the same material as the housing 20 and may have a perimeter shape that is configured to be complementary to the bottom end 26 such that the base 40 fits within or is otherwise attached to the housing 20 at the bottom end 26. If the housing 20 is made from a polymer such as PVC, the base 40 may be made of an alloy, metal or otherwise heavier material to allow for the proper functioning of the spring mechanism as to be described below.

In one embodiment, the housing 20 may be between about 5 inches to 8 inches in height and defines the cavity 22. In another embodiment, the housing 20 may have a height that is about 6 inches or about 6.25 inches. The cavity may have an inner diameter that is between 3 inches to 6 inches with an outer diameter that is between 3.5 inches and 6.5 inches. In a preferred embodiment, the inner diameter is about a 4 inches and the outer diameter is about 4.5 inches. The sidewall 24 may be between about ⅛ inches to about 1 inch thick. In a preferred embodiment, the sidewall 24 is about 0.25 inches thick. In an embodiment, the base 40 may have a generally circular shape, may be made of aluminum and may be between 3 inches to 6 inches in diameter. In a preferred embodiment, the base 40 has a 4 inch diameter. Further, the base may be about ⅛ inches to about 1 inch in thickness and preferably be about 0.25 to about 0.5 inches thick. However, any size of the housing 20 and base 40 are contemplated herein sufficient to operate as described.

The cap 50 may be attached to the housing 20 by the closing spring hinge mechanism 60. The cap 50 may be formed separately from the housing but is configured to be attached to the open end 28 of the housing 20 and configured to be biased between the open and closed positions. In one embodiment, the cap 50 has a perimeter edge 52 that is generally complimentary to the open end 28 of the housing 22 such that the perimeter edge 52 of the cap 50 extends outwardly from the inner surface of the cavity 22. Here, at least a portion of the cap 50 abuts against the rim 32 of the housing 20 when in the closed position. In one embodiment, the cap 50 has a perimeter edge 52 that is generally rounded or circular.

Further, a plurality of magnets 54 may be positioned along the rim 32 of the housing 20 or along the perimeter of the cap 50 and be configured to magnetically attract to the cap 50 or the rim of the housing 20 depending on the location and position of the magnets. As such, the cap 50 may be made of a metal or alloy that has magnetic properties or a portion of the cap 50 that complements the positions of the magnet(s) 54 may be formed of a metal or alloy. In one embodiment, at least one of the magnets 54 may be fit within recesses positioned along the rim 32. Notably, this disclosure contemplates that any number or configuration of magnets may be utilized and can particularly include any number between one to seven or more magnets 54. The magnetic attraction between the cap 50 and the rim 32 may be strong enough to support the cap 50 in the closed position as the assembly 10 is tripped or knocked and positioned upside down and maintain the candle 30 within the cavity 22. The strength of the magnetic force may be such that also allows a user to easily grasp the cap 50 along a portion of the periphery and manually overcome the magnetic force and closing spring hinge mechanism to bias the cap 50 from the closed to the open position.

FIG. 12 illustrates the cap 50 separate from the assembly 10 and illustrates the perimeter edge 52 having a generally curved or circular configuration. The perimeter edge 52 may have a shape that is modified for attachment with the closing spring hinge mechanism 60. As such, a cutout section or attachment portion 56 pay be placed along the perimeter edge 52. In one embodiment the attachment portion 56 includes a cutout or ledge 58. The cutout or ledge 58 may be placed along the perimeter edge 52 and in particular may be placed adjacent to the closing spring hinge mechanism 60 to interact with an elongated pin 70 as will be more fully described below.

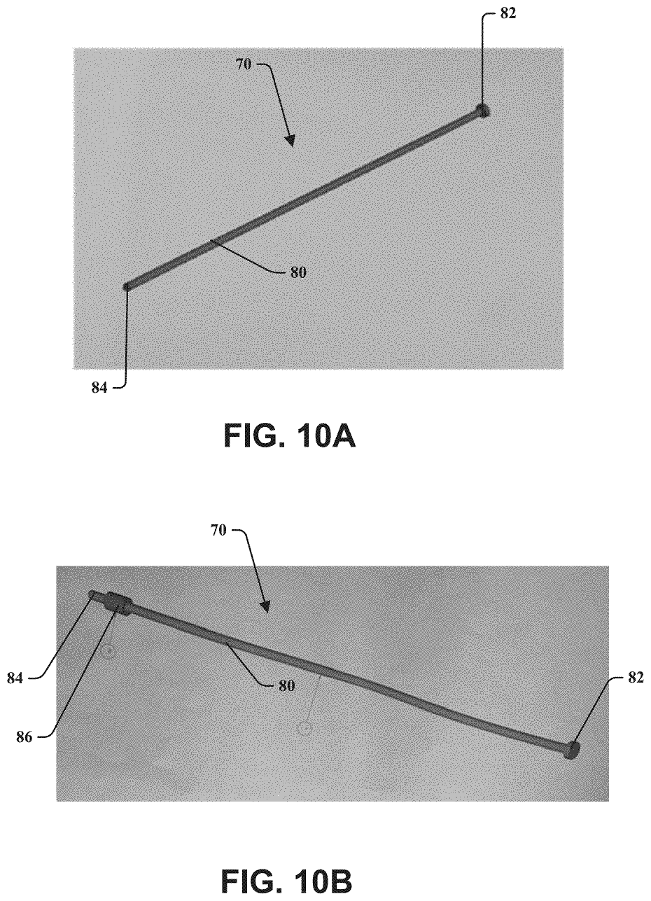

As illustrated by FIGS. 3, 4A, and 4B, the closing spring hinge mechanism 60 may include a first plate 62, a second plate 64, a biasing member 66, a rod 68, and an elongated pin 70 (FIGS. 10A and 10B). The first plate 62 may be attached to the housing 20 and the second plate 64 may be attached to the cap 50. This attachment may be made by any appropriate manner such as adhesive, snap fit or with conventional fasteners such as screws as illustrated by the figures. FIG. 10A illustrates an embodiment of the elongated pin 70 without a bushing while FIG. 10B illustrates an embodiment of the elongated pin with a bushing 86. The bushing 86 may be a press fit along the length of the

The first plate 62 may be rotatably attached to the second plate 64 in various manners. In an embodiment, the rod 68 and the biasing member 68 are configured to place a bias force against the closing spring hinge mechanism 60 to bias the first plate 62 towards the second plate 64. The rod 68 may be positioned along a pivot axis 72 and may extend from a first connection member 74A to a second connection member 74B. The first connection member 74A may be attached to and extend from the second plate 64 and the second connection member 74B may be attached to and extend from the first plate 62 each along the pivot axis 72. A first bearing member 76A may extend generally perpendicularly from the first plate 62 and include an aperture to receive and rotatably support the rod 68 therein. A second bearing member 76B may extend generally perpendicularly from the second plate 64 and include an aperture to receive and rotatably support the rod 68 therein. The first bearing member 76A may be spaced from the second bearing member 76B along the pivot axis. In one embodiment, the biasing member 66 may be a spring that is supported along the rod 68 and which a proximal end of the spring is retained along the first bearing member 76A and a distal end of the spring is retained along the second bearing member 76B. The biasing member 66 may also incorporate other configurations that are designed to provide a bias force to pivot the first plate 62 relative to the second plate 64 towards the closed position.

In one embodiment, the first plate 62 may include first and second arms 78A, 78B that are spaced apart from one another and separately attached to the housing 20 by fasteners. The arms 78A, 78B may be set in recessed areas along the surface of the housing 22 and attached thereto with fasteners. The second plate 64 may include a space that extends between the first and second connection members 74A, 74B wherein the remaining portions of the second plate 64 is attached to the cap 50 with fasteners. The notch or ledge 58 of the cap 50 may be located within the space of the second plate 64.

The elongated pin 70 may be inserted into a through hole 88 positioned along the rim 32 of the housing 20 and placed adjacent the closing spring hinge mechanism 60 and, in particular, placed between the first and second connection members 74A, 74B. The elongated pin 70 may have a slender body 80 with an enlarged head 82 along a top side and an end 84 along the opposite bottom. The slender body 80 may fit within the through hole 88 that defines a lumen within the side wall 24 of the housing 20. The lumen may extend the entire length of the housing 20 from the rim 32 to the bottom end 26. The elongated pin 70 may be slightly longer than the housing 20 to allow the slender body 80 of the elongated pin 70 to extend therein and allow the enlarged head 82 to protrude upwardly from the rim 32 and be positioned between the first and second bearing members 76A, 76B or between the first and second connection members 74A, 74B of the closing spring hinge mechanism 60. FIG. 10A illustrates an embodiment of the elongated pin 70 without a bushing while FIG. 10B illustrates an embodiment of the elongated pin with a bushing 86. The bushing 86 may be a press fit along the length of the slender body 80 generally adjacent but spaced from the end 84. The bushing 86 and through hole 88 may be configured such that a counterbore portion 89 (FIG. 4A) of the through hole 88 along the bottom of the housing 20 may allow the bushing 86 to be received therein to prevent the elongated pin 70 from being removed from the through hole 88. The counterbore portion 89 may define an inner radial shoulder within the through hole 88 to provide a stop that engages the bushing 86 to prevent removal of the elongated pin 70 from the rim 32 of the housing 20. The length between the end of the elongated pin 70 and the position of the bushing 86 may be a predetermined length to allow for the correct translation of the pin 70 within the through hole 88 to allow for the proper function of the candletrap assembly 10 as described herein.

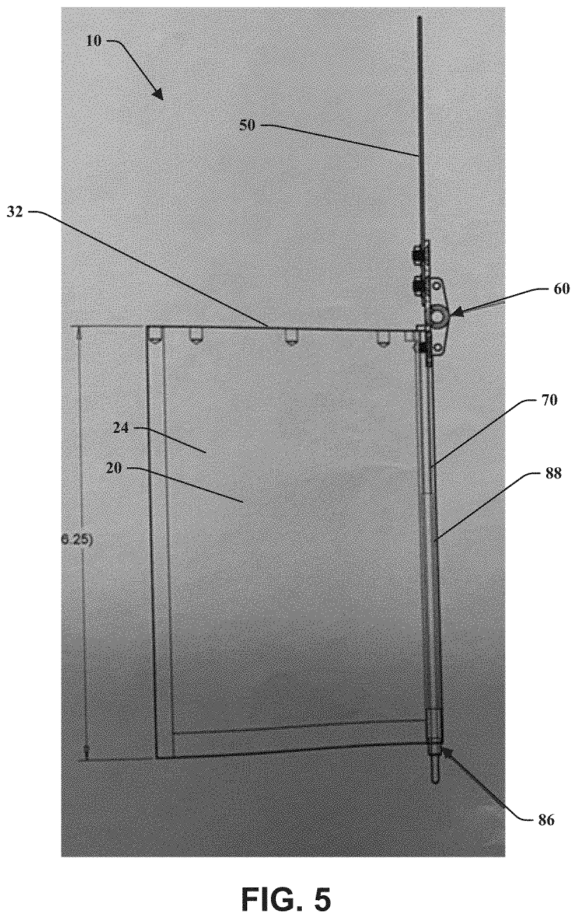

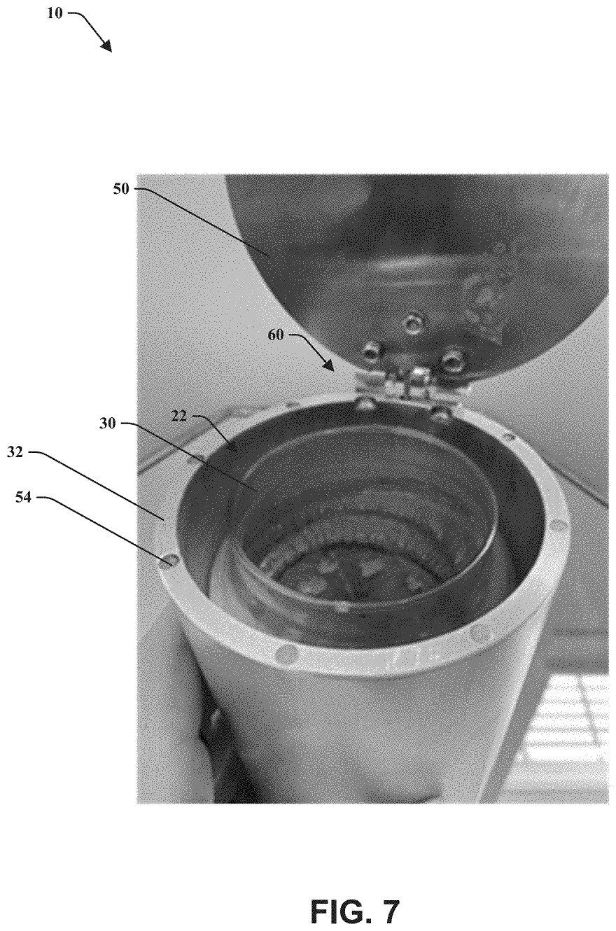

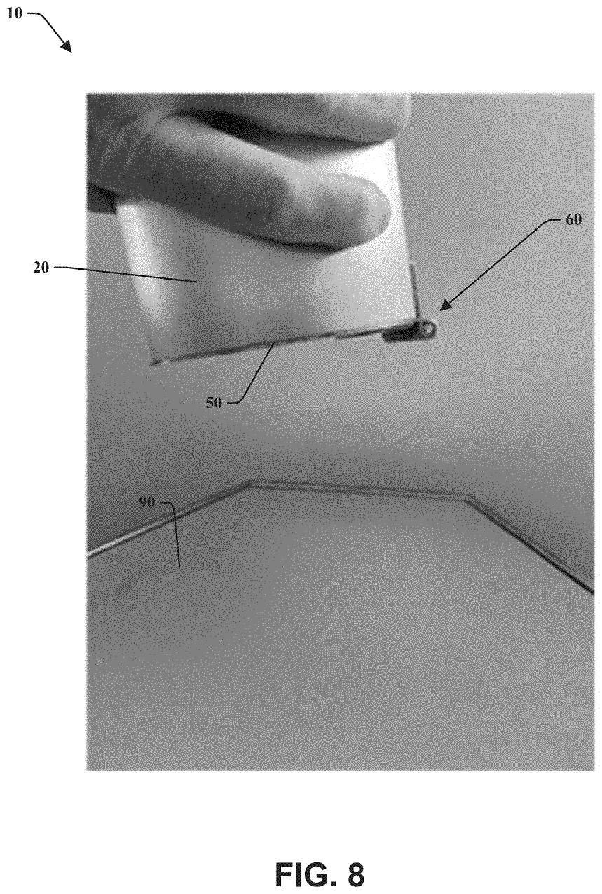

When the cap 50 is attached to the second plate 64 and biased in the open position, the enlarged head 82 of the elongated pin 70 may be placed against the ledge 58 of the cap 50. The length of the elongated pin 70 is such that the end 84 may abut against a surface 90 as the base 40 or bottom 26 also rests on the surface 90. In this position, the enlarged head 82 extends from the through hole 88 and is spaced from the rim 32 and is configured to be manually placed in engagement against the ledge 58 of the cap 50. In this instance, the cap 50 is held in the open position relative to the housing 20 (see FIGS. 2, 4A, 4B, 5 and 7) by the elongated pin 70 of the closing spring hinge mechanism 60. Here, the enlarged head 82 works against the bias force of the biasing member 66 of the closing spring hinge mechanism 60 and provides a hold open force. The hold open force is provided through the elongated pin 70 as the end 84 of the elongated pin 70 is in abutment with the surface 90.

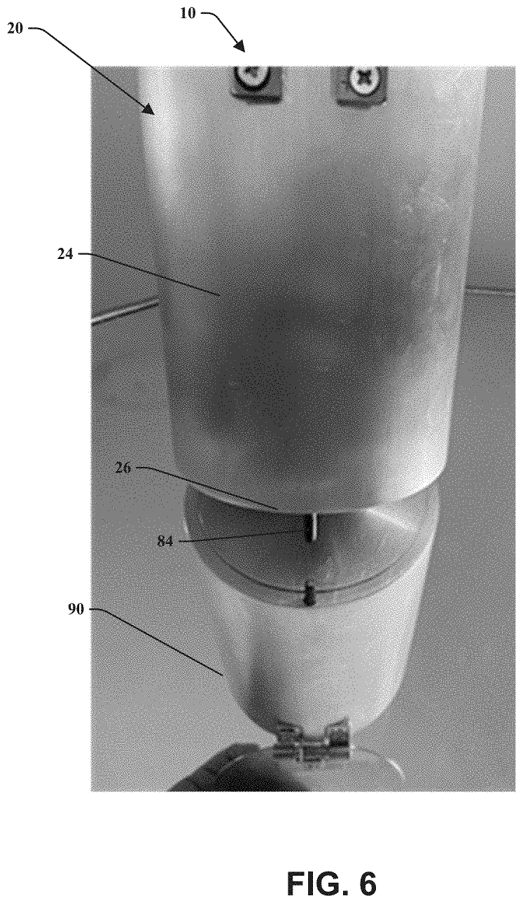

Once the bottom 28 of the housing 20 is tipped, nudged, lifted, or bumped relative to the surface 90 (see FIG. 6), the end 84 of the elongated pin 70 is moved from abutment with the surface 90 and moved away from alignment with the bottom 26 of the housing 22. The bias force of the closing spring hinge mechanism 60 works against the enlarged head 82 and automatically disengages the ledge 58 from the enlarged head 84. Thus, the hold open force is removed and the biasing member 66 of the closing spring hinge mechanism 60 automatically pivots the cap 50 to the closed position against the open end 28 of the housing 20.

Notably, the size of the elongated pin 70 relative to the length of the housing 20 and the position of the cutout or ledge 58 assist to allow for the automatic closing of the cap 50 when the housing is tipped relative to the surface 90. As such, the configuration of the elongated pin 70 allows for the enlarged head 82 to be placed against a portion of the cap 50 to hold it in the engaged open position.

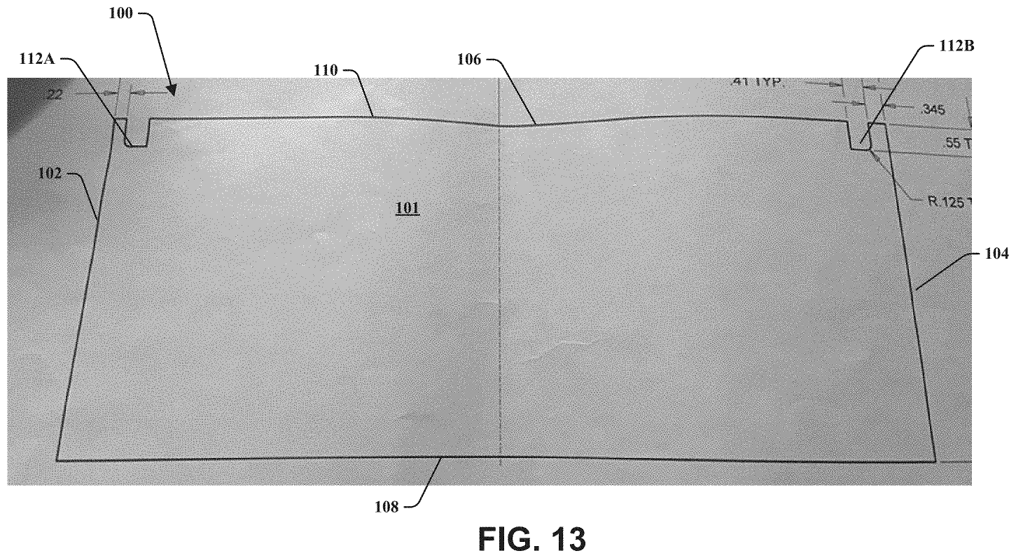

FIG. 13 illustrates a replaceable surface cover 100. The cover 100 may be a made from a vinyl material and include various types of indicia thereon. The cover 100 may include a first exposed side 101 with indicia thereon and an opposite second side with an adhesive layer. The indicia may be any design, color, font, letters, words, numbers, pictures or images. The adhesive layer may allow the cover 100 to wrap around the entire outer surface of the housing 20. The cover 100 may be a replaceable surface cover that includes a perimeter shape 110 that is generally complimentary to the outer surface of the candletrap assembly 10 as described herein. In particular, the perimeter shape 110 of the cover 100 may include a first edge 102 and an opposite second edge 104 with a top edge 106 and a bottom edge 108. The cover 100 is configured to wrap around the outer surface of the housing 20 such that the adhesive side is placed along the housing to allow the first edge 102 to be placed in abutment with or generally aligned with the second edge 104. The abutment between the first and second edges 102, 104 may be aligned with the hinge mechanism 60 along the housing 20.

In an embodiment, a first notch 112A and a second notch 112B are positioned along the top edge 106 wherein the first and second notches 112A, 112B are configured to be generally complimentary to the shape of the hinge mechanism 60. More particularly, the first and second notches 112A, 112B are generally complimentary to the first plate 62 as the first notch 112A may be positioned around the second arm 78B and the second notch 112B may be positioned around the first arm 78A. This configuration may allow a user to replace and reuse various covers 100 of various designs along the housing 20 of the candletrap assembly 10.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The features of each embodiment described and shown herein may be combined with the features of the other embodiments described herein. The claims as follows are intended to include all modifications and alterations insofar as they come within the scope of the claims or the equivalent thereof.

Having thus described the invention, I claim:

1. A candletrap assembly comprising:
a housing with a sidewall that defines a cavity, the sidewall having a bottom end and an open top end, the top end is defined by a rim, a base is positioned on the bottom end of the housing;
a cap;
a spring hinge mechanism attached to the housing adjacent the open top end and the cap wherein the spring hinge mechanism is configured to be biased to position the cap between an open position and a closed position relative to the open end of the housing; and
an elongated pin extending through at least a length of the housing wherein the elongated pin is configured to hold the cap in the open position against a bias force of the spring hinge mechanism.

2. The candletrap assembly of claim 1, wherein the housing includes a generally cylindrical shape.

3. The candletrap assembly of claim 1, wherein the base is formed separately from the housing and attached to the bottom end.

4. The candletrap assembly of claim 1, wherein the cap has a perimeter edge that has a shape that is generally complimentary to the open end of the housing such that the perimeter edge of the cap extends outwardly from the inner surface of the cavity wherein at least a portion of the cap abuts against the rim of the housing when in the closed position.

5. The candletrap assembly of claim 1, wherein the cap has a perimeter edge that is generally circular.

6. The candletrap assembly of claim 1 further comprising a plurality of magnets positioned along the rim of the housing and be configured to magnetically attract to the cap wherein the cap comprises a magnetically attractive material.

7. The candletrap assembly of claim 6 wherein a magnetic attraction between the cap and the at least one magnet positioned along the rim may be strong enough to support the cap in the closed position as the assembly is positioned upside down to maintain a candle within the cavity.

8. The candletrap assembly of claim 1 wherein the cap includes a peripheral edge having a generally curved or circular configuration with a cutout section placed along the perimeter edge that includes a ledge.

9. The candletrap assembly of claim 8 wherein the ledge is placed adjacent to the closing spring hinge mechanism to interact with the elongated pin.

10. The candletrap assembly of claim 1 wherein the closing spring hinge mechanism includes a first plate, a second plate, a biasing member, and a rod, wherein the first plate is attached to the housing and the second plate is attached to the cap wherein the biasing member is configured to bias the first plate towards the second plate to close the cap relative to the open end of the housing.

11. The candletrap assembly of claim 10 wherein the rod is be positioned along a pivot axis and extends from a first connection member to a second connection member;
the first connection member extends from the second plate and the second connection member extends from the first plate along the pivot axis;
a first bearing member extends generally perpendicularly from the first plate and supports the rod and second bearing member extends generally perpendicularly from the second plate and supports the rod wherein the first bearing member is spaced from the second bearing member along the pivot axis.

12. The candletrap assembly of claim 11 wherein the biasing member is a spring that is positioned along the rod.

13. The candletrap assembly of claim 11 wherein the first plate includes first and second arms that are spaced apart from one another and separately attached to the housing and the second plate includes a space that extends between the first and second connection members such that a ledge of the cap is positioned within the space of the second plate.

14. The candletrap assembly of claim 1 wherein the elongated pin extends through the housing to abut against a surface and a portion of the cap to hold the cap in an open position against the bias force of the biasing member

15. The candletraps assembly of claim 14 wherein the closing spring hinge mechanism is configured to automatically bias the cap to a closed position against an open end of the housing once the elongated pin is removed from a portion of the cap.

16. The candletrap assembly of claim 1 wherein the elongated pin includes a head and an end wherein the elongated pin is positioned within a through hole that extends between the rim of the housing and a bottom of the housing such that the head of the elongated pin is placed adjacent the closing spring hinge mechanism wherein the elongated pin is longer than a length of the housing to allow the end of the elongated pin to abut against a surface and to allow the head to protrude upwardly from the rim.

17. The candletrap assembly of claim 16 wherein the elongated pin includes a bushing positioned adjacent to the end.

18. The candletrap assembly of claim 1, wherein the head of the elongated pin is configured to be manually placed against a ledge of the cap to place the cap in the open position.

19. The candletrap assembly of claim 1 wherein once the bottom of the housing is tipped, nudged, lifted, or bumped relative to a surface, an end of the elongated pin is moved from an abutment with the surface and moved away from alignment with the bottom of the housing wherein a bias force of the closing spring hinge mechanism biases against the head and the head disengages from the ledge and the closing spring hinge mechanism pivots the cap to the closed position against the open end of the housing.

20. The candletrap assembly of claim 1 further comprising a replaceable surface cover configured to wrap around the outer surface of the housing and include first and second notches that are generally complementary shaped relative to the spring hinge mechanism.
